(19) United States
(12) Patent Application Publication
(10) Pub. No.: US 2016/0127483 A1
(43) Pub. Date: May 5, 2016

(54) METHOD AND DEVICE FOR DISPLAYING ITEM CONTENT

(71) Applicant: Xiaomi Inc., Beijing (CN)

(72) Inventors: Yi Gao, Beijing (CN); Hongqiang Wang, Beijing (CN); Hai Long, Beijing (CN)

(73) Assignee: XIAOMI INC., Beijing (CN)

(21) Appl. No.: 14/692,340

(22) Filed: Apr. 21, 2015

Related U.S. Application Data
(63) Continuation of application No. PCT/CN2015/071277, filed on Jan. 22, 2015.

(30) Foreign Application Priority Data
Oct. 31, 2014 (CN) 201410602097.3

(51) Int. Cl. H04L 29/08; G06F 3/0484; G06F 17/30

(52) U.S. Cl. CPC H04L 67/18; G06F 17/30241; G06F 3/04842; G06F 17/3051

(57) ABSTRACT

A method and a device for displaying reminder item content on a lock screen interface of a terminal are described. The device may implement the method described. The device may acquire a current geographical position of the terminal when displaying the lock screen interface. The device may detect whether the current geographical position is within a display range of the reminder item. If the current geographical position is within the display range, the device may display the reminder item content on the lock screen interface. Further, when the reminder item content is displayed on the lock screen interface, and if the current geographical position of the terminal is outside the display range but within a reminding range, then the user may be prompted about the reminder item content displayed on the lock screen interface.

This application is a continuation of International Application No. PCT/CN2015/071277, filed Jan. 22, 2015, which is based upon and claims priority to Chinese Patent Application No. 201410602097.3, filed Oct. 31, 2014, the entire contents of which are incorporated herein by reference.

### TECHNICAL FIELD

The present disclosure relates to the field of computer technology, and more particularly, to a method and a device for providing a reminder.

### BACKGROUND

A user may carry a terminal that may provide a reminder corresponding to a reminder item.

The user may setup the reminder item using the terminal. For example, the user may record the reminder item in the terminal and set a reminding time for the reminder item. At the setup reminding time, the terminal may provide a reminder through a ring or a vibration.

### SUMMARY

The present disclosure provides a method and a device for providing a reminder to a user. The technical solutions are as follows.

One general aspect includes a method for displaying an interface item for a reminder item. The method may include acquiring a current geographical position of a terminal when displaying a lock screen interface of the terminal. The method may include detecting whether the current geographical position is within a display range of the reminder item. The method may include displaying the interface item on the lock screen interface in response to the current geographical position being within the display range of the reminder item. The interface item may display content of the reminder item.

In another general aspect, a device for providing a reminder is described. The device may include a processor and a memory for storing instructions executable by the processor. The processor may display a lock screen interface of a terminal. The processor may determine a current geographical position of the device. The processor may setup a reminder item, where the reminder item has a corresponding display range, which is a geographical range. The processor may identify the current geographical position being within the geographical range of the reminder item. The processor may display content of the reminder item on the lock screen interface in response to the current geographical position being within the geographical range.

According to yet another aspect, a non-transitory readable storage medium including instructions that are executable by a processor in a terminal for performing a method for providing a reminder via the terminal is provided. The method may include displaying a lock screen interface of a terminal. The method may include detecting a current geographical position of the terminal. The method may include determining the current geographical position being within a display range of a reminder item, the display range being a geographical range. The method may include triggering the reminder for the reminder item by displaying content of the reminder item on the lock screen interface in response to the current geographical position being within the display range of the reminder item.

According to a third aspect of the embodiments of the present disclosure, there is provided a non-transitory readable storage medium including instructions, executable by a processor in a terminal, for performing a method for displaying item content, the method including:

when displaying a lock screen interface of a terminal, acquiring a current geographical position of the terminal;

detecting whether the current geographical position is within a display range of a reminding item; and

if the current geographical position is within the display range of the reminding item, displaying item content of the reminding item on the lock screen interface.

It is to be understood that both the foregoing general description and the following detailed description are exemplary and explanatory only and are not restrictive of the invention.

### BRIEF DESCRIPTION OF THE DRAWINGS

The examples described in the present document may be better understood with reference to the following drawings and description. The components in the figures are not necessarily to scale. Moreover, in the drawings, like-referenced numerals designate corresponding parts throughout the different views.

FIG. 1 illustrates an example logic for displaying reminder item content.

FIG. 2A illustrates an example logic for displaying reminder item content.

FIG. 2B illustrates an example block diagram of an interface to setup a reminder item on a lock screen.

FIG. 2C illustrates an example block diagram of setting up a reminding range.

FIG. 2D illustrates an example block diagram of displaying content of a reminder item on a lock screen interface.

FIG. 2E illustrates an example block diagram of displaying content of a reminder item on a lock screen interface.

FIG. 3 illustrates an example block diagram of a device for displaying content of a reminder item.

FIG. 4 illustrates an example block diagram of a device for displaying content of a reminder item.

FIG. 5 illustrates an example block diagram of a device for displaying content of a reminder item.

### DETAILED DESCRIPTION

The examples set forth in the following description do not represent all implementations of the technical solutions provided by the description. Instead, they are merely examples of devices and methods consistent with some aspects of the technical solutions.

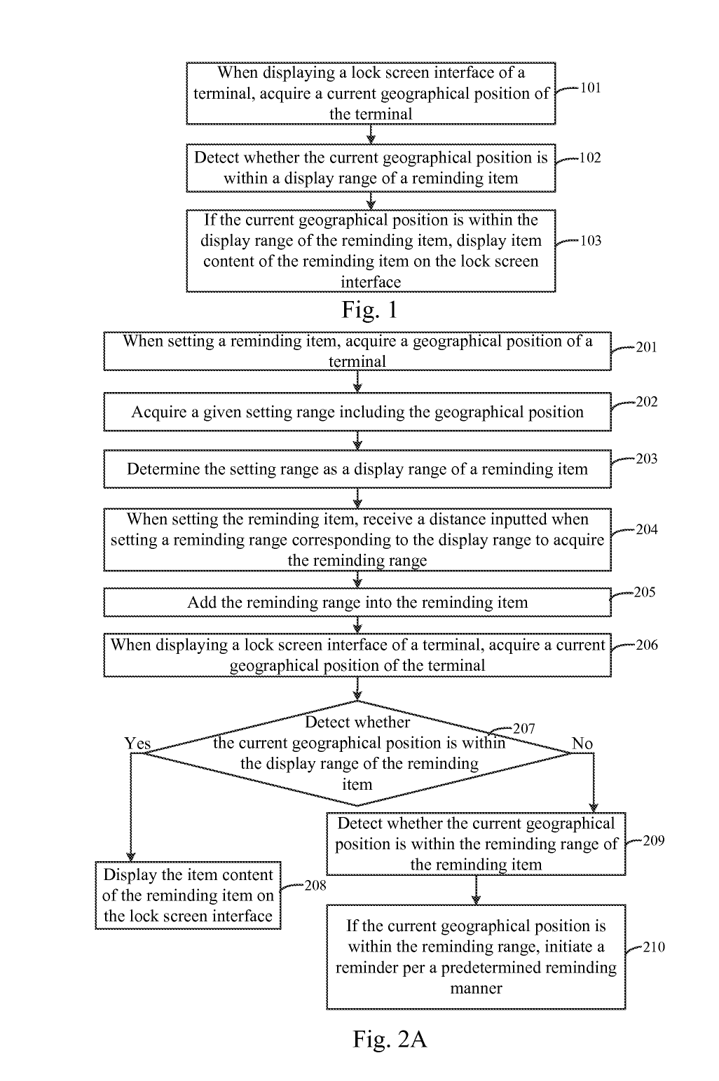

FIG. 1 illustrates an example logic for displaying reminder item content. The logic is represented as a flow chart. The logic illustrated in FIG. 1 may be a method applied, or implemented in a terminal. The terminal may be a smartphone, a tablet computer, a smart TV, an e-book reader, a multimedia player, a laptop portable computer, a desktop computer and the like. The method for displaying content of a reminder item may include at least the following steps.

In step 101, the terminal may be displaying a lock screen interface of the terminal. When displaying the lock screen interface, the terminal may acquire a current geographical position of the terminal.

The lock screen interface is an interface displayed when the screen is switched on, but in a lock screen state. From the lock screen interface, the terminal cannot enter a main interface of the terminal unless the screen is unlocked.

For example, the user may view the lock screen interface when the user views the current time on the terminal. For example, the terminal may be in standby mode. The user may press a power button of the terminal. At this time, the screen of the terminal may turn on and display the lock screen interface. The lock screen interface may be frequently viewed by the user. The lock screen interface may be used to display prompts, such as reminder prompts. Using the lock screen interface to display reminders may improve efficiency, and the user may not miss important reminder items.

Thus, the terminal may display the reminder item content on the lock screen interface. The reminder item content may be text, image, or a combination thereof to provide a reminder to the user of the terminal. The user may enter or select the reminder item content when setting up a corresponding reminder item, or reminding item. The reminder item may be an entry recorded by the terminal, such as in a calendar, a clock, or any other application that facilitates providing reminders to the user. The user may setup the reminder item on the terminal or any other device, so that the terminal provides a corresponding reminder according to the options selected during setup. When setting up the reminder item, the terminal may provide a menu item for a setting regarding using the lock screen interface to display information about the reminder item. The terminal may facilitate the user to customize the information of the reminder item displayed on the lock screen interface.

In step 102, the terminal may detect a current geographical position of the terminal. The terminal may further detect whether the current geographical position is within a display range of the reminder item.

The display range of the reminder item may define a geographical position, or location at which the terminal may display content of the reminder item. In other words, the terminal cannot display the content of the reminder item on the lock screen interface unless the terminal is within the display range of the reminder item. The present document may use ‘geographic’ and ‘geographical’ interchangeably. The display range may be defined as an area within a certain distance from a certain geographical position. For example, an area within 5 meters from a door of a house. The door of the house may be located based on GPS coordinates, triangulation of communication signal(s), or any other location identification technique. The display range may be defined within different ranges in different examples. In one example, the display range may be within a meter to several kilometers. In another example, the display range may be 1 meter to 0.5 (half) kilometer. The display range may be expressed in different units, such as feet, miles, or any other. The display range may be defined in other ways, instead of a distance from a position, in other examples. For example, the display range may be defined as a polygon formed by a set of coordinates. Other examples are possible.

In step 103, if the current geographical position is within the display range of the reminder item, the content of the reminder item may be displayed on the lock screen interface.

Thus, according to a method for displaying content of a reminder item when displaying the lock screen interface of the terminal, in response to a current geographical position of the terminal being within a display range of the reminder item, the content of the reminder item may be displayed on the lock screen interface. Since the content of the reminder item may be displayed on the lock screen interface of the terminal if the terminal is within the display range, the problem of a limitation of providing a reminder only according to time is solved. Accordingly, the method may implement an improved and effective way to provide a reminder in the set display range and as per the reminding frequency.

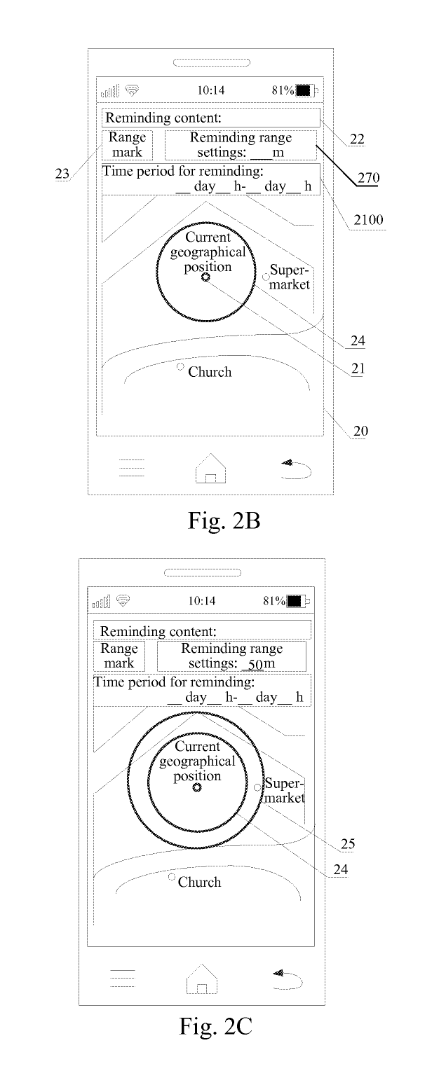

FIG. 2A illustrates an example logic for displaying reminder item content. The logic is represented as a flow chart. The logic shown in FIG. 2A may be a method for displaying reminder item content as applied in the terminal. The terminal described herein may be a smartphone, a tablet computer, a smart TV, an e-book reader, a multimedia player, a laptop portable computer, a desktop computer and the like. The method for displaying the reminder item content may include at least the following steps.

In step 201, when setting up the reminder item, the terminal may identify a geographical position of the terminal.

The geographical position range may be associated with the reminder item. The associated geographical position range may improve effectivity of the set reminder item. The geographical position range is approximate, and based on the position where the user sets up the reminder item content. For example, the reminder item may be to remind the user to carry a key (the reminder content) at the door (the set range) of the house of the user. Since the user may carry the key in the house or near the door of the house, the position for the user to carry the key may be close to the position of the door of the house of the user. Associating the geographical range close to the door with the reminder to carry the key may be a convenient way for reminding the user to complete the corresponding objective of the reminder item when the user is in close proximity of the door. Thus, the reminder being provided in the set geographical range may improve the user experience.

Therefore, when setting the range of the reminder item, the terminal may acquire the geographical position of the terminal. The geographical position may be acquired through a Global Positioning System (GPS), which may be a part of the terminal.

For example, the user may configure or customize the lock screen interface, such as by clicking a menu item “customize lock screen information.” The menu may be accessible via lock screen settings of the terminal. The terminal may display a corresponding setting interface of “lock screen information setting and reminding unit.” In this setting interface, an input box for setting the reminder item may be displayed, and the user may be prompted to input customized reminder content. Meanwhile, the GPS of the terminal may be turned on. A map interface may be displayed on the interface. The map may be updated based on position information acquired by the GPS.

FIG. 2B illustrates an example block diagram of an interface to setup a reminder item on a lock screen. The setting interface 20 may display a map including the geographical position 21 of the terminal. In the map, the geographical position 21 of the terminal may be marked. Accordingly, when setting the reminder item in the setting interface 20, the user may input the customized reminding content in an input box 22 for reminding content.

In step 202, the terminal may receive a range setting 270 to determine a geographical range surrounding the geographical position.

The reminding range set for the reminder item may include the geographical position of the terminal.

Referring to FIG. 2B, after clicking a range mark setting control 23, the user may define a closed area around the geographical position 21. The closed area may be the display range 24 of the reminder item. The closed area may include the geographical position 21; that is, the display range 24 may include the geographical position 21 of the terminal.

A shape formed by an edge, or boundary of the display range 24 may be a circle, an oval, a rectangle, a triangle, or a polygon. The shape formed by the edge of the display range 24 may be other than those listed in this document.

In step 203, the setting range 270 may be determined as the display range of the reminder item.

The setting range 270 defined while setting the reminder item may be determined as the display range 24 of the reminder item.

In step 204, when setting the reminder item, a distance value inputted when setting a reminding range corresponding to the display range 24 may be received to acquire the reminding range.

For example, when the terminal is within the display range 24, the user may not view the lock screen interface of the terminal. At this time, the reminder item corresponding to the display range 24 may not be displayed, and the user may not receive a reminder of the reminder item. In order to avoid the user missing the reminder item, a reminding range may also be set for the reminder item. In this way, when the terminal is outside the display range 24 but within the reminding range, a reminder of the reminder item may be provided.

Additionally or alternatively, when setting the reminder item, the reminder item may be set according to the currently set display range 24. For example, a range formed N meters away from the original display range may be used as the reminding range. That is, the center of the reminding range and the center of the display range may be the same; the reminding range may be larger than the display range, and the distance between an intersection point of any ray emitted from the central point of the display range on the edge shape of the reminding range and an intersection point of the ray on the edge shape of the display range is equal to the received distance. That is, a figure formed by the edge of the reminding range and a figure formed by the edge of the display range may be concentric figures.

For example, if the figure formed by the edge of the display range is a circle, the figure formed by the edge of the reminding range may also be a circle. The circle formed by the edge of the display range and the circle formed by the edge of the reminding range may be concentric circles. The circle formed by the edge of the display range may be smaller than the circle formed by the edge of the reminding range.

In another example, when the figure formed by the edge of the display range is a rectangle, the figure formed by the edge of the reminding range may also a rectangle. The rectangle formed by the edge of the display range and the rectangle formed by the edge of the reminding range may be concentric rectangles. The rectangle formed by the edge of the display range may be smaller than the rectangle formed by the edge of the reminding range.

FIG. 2C illustrates an example block diagram of setting up a reminding range. When the display range 24 is set, a distance value inputted when setting a reminding range 25 corresponding to the display range 24 may be set in the position for setting the reminding range 270. For example, the reminding range may be set as 50 meters as shown in FIG. 2C. The reminding range may be used to calculate the reminding range 25 corresponding to the display range 24. The display range 24 and the reminding range 25 in FIG. 2C are concentric circles; the reminding range 25 is larger than the display range 24; and the radius of the reminding range 25 is greater than the radius of the display range by 50 meters.

In step 205, the reminding range 25 may be associated with the reminder item.

The set reminding range may be associated with the reminder item; thus, the reminder item may include the reminding content 22, the display range 24, and the reminding range 25.

In step 206, when displaying the lock screen interface of the terminal, the current geographical position of the terminal may be acquired.

For example, the lock screen interface of the terminal may be displayed by pressing the power button of the terminal to turn on the screen of the terminal. The lock screen interface may be displayed on the turned on screen. In order to determine whether to display the reminder item on the lock screen interface, the current geographical position of the terminal may be acquired.

For example, the geographical position of the terminal may be acquired through the GPS disposed in the terminal. Alternatively or in addition, the geographical position may be acquired by triangulating a communication signal of the terminal, or based on an IP address, or any other technique to identify a location of the terminal.

In step 207, whether the current geographical position is within the display range of the reminder item may be detected.

In an example, a plurality of reminder items may be set, each reminder item being provided with a corresponding display range. When in use, after acquiring the current geographical position of the terminal, whether the current geographical position is within a display range of a certain or some reminder items may be detected.

In step 208, if the current geographical position is within the display range of the reminder item, the item content of the reminder item may be displayed on the lock screen interface.

If the current geographical position is within the display range of the reminder item, then the item content of the reminder item may be displayed on the lock screen interface. Thus, the user may see the corresponding reminding content while viewing the lock screen interface.

FIG. 2D illustrates an example block diagram of displaying content of a reminder item on a lock screen interface. The example in FIG. 2D displays the reminding content of “do not forget to carry the key” on the lock screen interface 26. The reminding content may be displayed as an interface item such as a text, an image, or any other user interface element or a combination thereof. The interface item may display content of the reminder item that may be input as the reminding content 22.

Alternatively or in addition, when the lock screen interface 26 displays the content of the reminder item, the user may be provided with a first option and a second option. If the first option is selected, then the item content of the reminder item may be displayed again when displaying the lock screen interface 26 of the terminal again; and if the second option is selected, then the item content of the reminder item may be removed from the lock screen interface, so that the next time the lock screen interface 26 is displayed, the reminder item content is not displayed.

FIG. 2E illustrates an example block diagram of displaying content of a reminder item on a lock screen interface, where a reminding content of “do not forget to carry the key” is displayed on the lock screen interface 26. Further, the lock screen interface 26 may display a first option 27 and a second option 28 for the user to select. If the first option 27 is selected, then the reminding content of “do not forget to carry the key” of the reminder item may be displayed again when displaying the lock screen interface 26 again. If the second option 28 is selected, then the reminding content of “do not forget to carry the key” of the reminder item may not be displayed any longer when displaying the lock screen interface 26 again. Alternatively or in addition, a third option 29 may be displayed and selected for the reminder content. If the third option is selected, the reminder settings when displaying the lock screen interface 26 again may be ignored. Accordingly, the reminding content of “do not forget to carry the key” of the reminder item may be displayed again by default when displaying the lock screen interface 26 again. In an example, the first option 27, the second option 28, and the third option 29 may be controls that are displayed on the lock screen interface 26 and are selectable by the user in the lock screen state.

When setting up the reminder item via the setting menu item of the lock screen interface, the user may select a reminding manner for the lock screen interface. The reminding manner may be an interaction configuration that facilitates the user to customize what information is displayed when reminding about the reminder item. For example, the user may select to display only the reminding content of the reminder item. Alternatively, the user may select a reminding manner of displaying the reminding content of the reminder item along with the first option, the second option, or the third option. The user may also select more than one or all of the options to be displayed at the same time. Other combinations and configurations for the reminding manner may be possible, other than those described here.

In step 209, if the current geographical position is not within the display range 24 of the reminder item, the terminal may detect whether the current geographical position is within the reminding range 25.

If the current geographical position is not within the display range 24, to ensure that the user receives a reminder for the reminding content of the reminder item, the terminal may continuously monitor whether the current geographical position is within the reminding range 25.

In step 210, if the current geographical position is detected to be within the reminding range 25, then the reminder item is reminded according to the corresponding reminding manner.

In an example, when the current geographical position is detected to be within the reminding range 25 and if the reminder item is not yet been displayed in the display range 24 corresponding to the reminding range 25, a reminder for the reminder item may be displayed according to the predetermined reminding manner. For example, if the user carries the terminal within the display range 24 of the reminder item and does not view the lock screen interface 26, the user may not view the reminding content of the reminder item while the terminal was in the display range 24. When the user leaves the display range 24 but is still in the reminding range 25 (a region in the reminding range 25 not overlapped with the display range 24), a reminder for the reminder item may be provided according to the predetermined reminding manner. Thus, the terminal may ensure that the user views the reminder item.

In an example, providing a reminder for the reminder item by the terminal according to the predetermined reminding manner may include detecting an ambient light intensity of the terminal. The terminal may compare the ambient light intensity with a predetermined light threshold. If the ambient light intensity is greater, higher, or larger than the threshold, the screen of the terminal may be turned on to pop up a prompt box. The prompt box may display the reminding content in the reminder item on the screen.

Alternatively, if the ambient light intensity is smaller, lower, or lesser than the predetermined light threshold, a reminder for the reminder item may be provided via a vibration or an audible, such as a ring, beep or any other sound.

For example, the terminal may be carried in a pocket or a bag. Therefore, the user may not be in a position to directly view the reminding content on the locked screen interface, even if the screen illuminates to remind the user about the reminding content. Hence, the ambient light intensity of the terminal may be used to identify the environment of the terminal, and the reminder may be provided in different reminding manners, which may be selected according to the environment of the terminal. For example, when the ambient light intensity is larger than the predetermined light threshold, the terminal may identify that the terminal is in a place where the user can directly view the terminal screen, rather than in a bag or a pocket. Accordingly, the screen of the terminal may be turned on to pop up the prompt box to display the reminding content of the reminder item on the screen. Alternatively or in addition, the reminding content may be directly displayed on the screen itself. In another case, if the ambient light intensity is smaller than the predetermined light threshold, the terminal may possibly be in the bag or the pocket. Therefore, a reminder for the reminder item may be provided using the vibration manner and/or the audible. Thus, the terminal may ensure that the user can effectively and instantly view the reminder item.

Thus, according to the method for the reminder item content may be displayed on the lock screen interface of the terminal based on the geographical position of the terminal. If the current geographical position of the terminal is within a display range of the reminder item, then the reminder item content may be displayed on the lock screen interface. Accordingly, the technical problem, or limitation of providing a reminder only according to a time is solved; and consequently a terminal may provide a reminder more effectively by reminding the user in the set display range and the frequency of reminding may be improved.

As described in the examples throughout the present document, both the display range and the reminding range may be set for the reminder item. When the terminal is outside the display range but within the reminding range, the terminal may prompt the user using a vibration or a ring, rather than just a screen prompt. Thus, the user may not miss the reminder item due to not viewing the lock screen interface within the display range.

The terminal may determine a manner of providing the reminder based on an environment of the terminal. For example, when the ambient light intensity of the terminal is larger than the predetermined light threshold, the screen of the terminal may be turned on to pop up the prompt box for displaying the reminding content of the reminder item on the screen. Alternatively, when the ambient light intensity of the terminal is smaller than the predetermined light threshold, the terminal may alternatively or additionally, use a vibration or a ring to prompt the user. Therefore, the problem that the user cannot be effectively reminded of the displayed reminder item when the terminal is put in a pocket or a bag is solved. Thus, the user may be effectively reminded of the relevant reminder item even when the terminal is not in direct view of the user, such as in a pocket or a bag.

In another example, in step 210, after providing a reminder according to the predetermined reminding manner, the reminder item may be modified. For example, the reminder item may be disable from providing further reminders in the reminding range. The reminder item may, alternatively or in addition, be modified so as to not provide a reminder any longer. That is, if the user is reminded within the reminding range once, then the reminder item will not trigger another reminder within the reminding range. In an example, the user may set the user's house as the display range of the reminder item, and the community where the house is located as the reminding range. In this case, when the user does not view the reminder item in the house, and the user leaves the house and enters the reminding range (a region in the community excluding the house of the user), the terminal may trigger a reminder. In this case, the user may receive the reminder prompt when the user has left the house already and is still within the community. If the reminder item is related to the position of the house, then the prompt may be provided only once, because the user may possibly not need to return to the house to perform an activity according to the reminder item. At this time, in order to avoid disturbing the user by frequent reminders, an attribute of the reminder item to provide a reminder in the reminding range may be modified to be no longer reminding. In this way, although the terminal is still within the reminding range, the terminal may not provide a reminder for the reminder item any longer. However, if the user is in the house, and the reminder item is related to the position of the house, then the user may be frequently reminded so that the user does not miss performing the activity according to the reminder item in the house.

After the user is reminded according to the predetermined reminding manner, the reminding attribute of the reminder item is modified so that a reminder is no longer provided for the reminder item within the reminding range. Thus, the user may not be disturbed by frequent reminders outside the display range but within the reminding range.

In another example, a time period for reminding may also be set in the reminder item. The terminal may display the item content of the reminder item based on the geographical location and the set time period. If the current time is within the time period for reminding, the terminal may display the item content. For example, when the terminal may display the reminder item content if the current time is within the reminding time period

When setting the reminder item, the setting interface may provide an input interface for setting the reminding time period. For example, in FIG. 2B, the interface 2100 may facilitate setting the time period for reminding the user.

The time period for reminding may be part of the settings of the reminder item. The item content of the reminder item may be displayed on the lock screen interface in response to both, the current time period and the current location of the terminal comply with the settings of the reminder item, particularly the reminding time period and the display range. Thus the examples described in the present disclosure prevent the user from being disturbed due to frequent reminders outside the reminding time period and/or the geographical range. Thus, the precision of the reminders by the terminal may be improved.

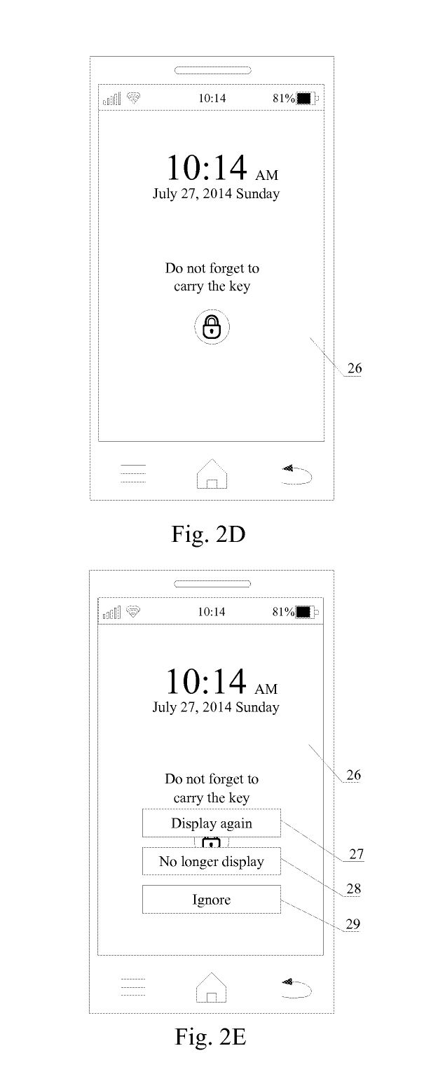

FIG. 3 illustrates an example block diagram of a device for displaying content of a reminder item. As shown in FIG. 3, the device for displaying item content may be part of a terminal. The terminal may be a smartphone, a tablet computer, a smart TV, an e-book reader, a multimedia player, a laptop portable computer, a desktop computer and the like. The device may include at least a first acquisition module 302, a first detection module 304, and a display module 306.

The first acquisition module 302 may acquire a current geographical position of the terminal when the terminal is displaying a lock screen interface.

The first detection module 304 may detect whether the current geographical position acquired by the first acquisition module 302 is within a display range of the reminder item.

The display module 306 may display reminder item content on the lock screen interface if the first detection module 304 detects that the current geographical position is within the display range.

Thus, the device may display the reminder item content on the lock screen interface of the terminal, if the current geographical position of the terminal is within the display range. Thus, the problem of limiting a reminder only based on time is solved. Thus, the device may implement a methods of providing a reminder in the set display range and improving frequency of the reminder.

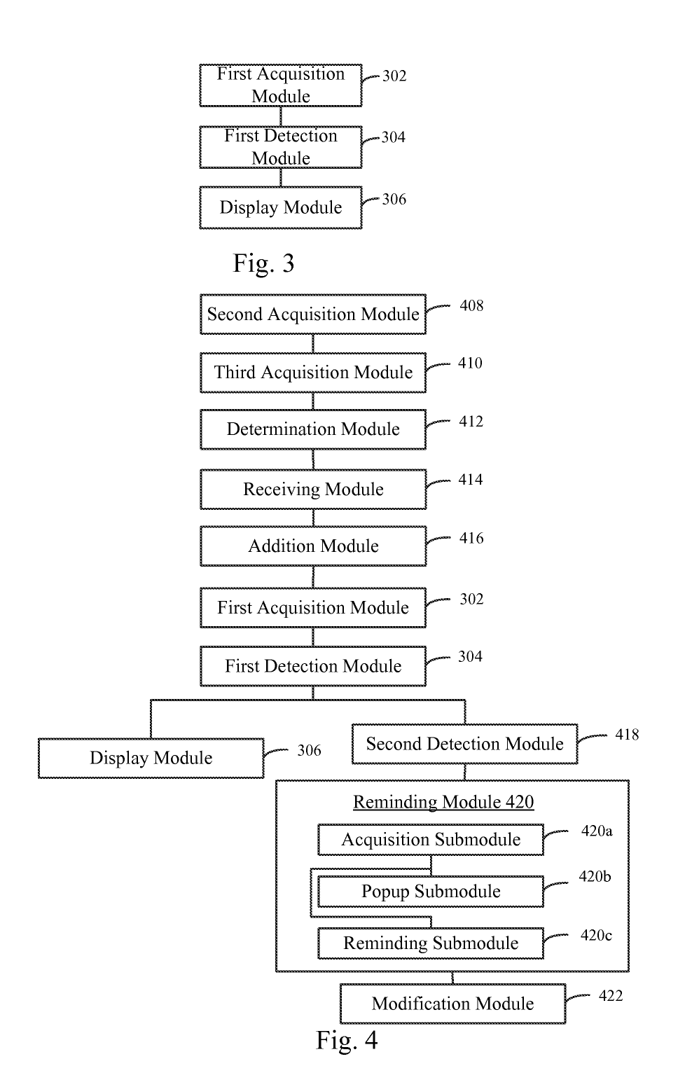

FIG. 4 illustrates an example block diagram of the device for displaying content of a reminder item. The device shown in FIG. 4 may be part of the terminal, and the terminal may be a smartphone, a tablet computer, a smart TV, an e-book reader, a multimedia player, a laptop portable computer, a desktop computer and the like. The device may include the first acquisition module 302, the first detection module 304, and the display module 406. In addition, the device may further include at least a second acquisition module 408, a third acquisition module 410 and a determination module 412.

The second acquisition module 408 may acquire a geographical position of the terminal when setting the reminder item. In an example, the second acquisition module 408 may be the same as the first acquisition module 302.

The third acquisition module 410 may acquire a setting range including the geographical position acquired by the second acquisition module 408.

The determination module 412 may determine the display range of the reminder item based on the setting range acquired by the third acquisition module 410.

In an example, the device may further include a receiving module 414 and an addition module 416.

The receiving module 414 may receive a distance value when setting the reminder item. The distance value may be used to determine a reminding range corresponding to the display range. The reminding range and the display range may share the same central point. The reminding range may be larger than the display range. Thus, the display range may and reminding range may be concentric and accordingly, any ray emitted from the central point first intersects the display range in a first intersection point and then intersects the reminding range in a second intersection point. A distance between the first intersection point on an edge of the display range and the second intersection point on an edge of the reminding range may be set equal to the received distance. Thus, the receiving module may calculate the reminding range based on the display range and the distance value input.

The addition module 416 may add the reminding range into the reminder item. Accordingly, the reminder item may be associated with the calculated reminding range.

In another example, the device may further include a second detection module 418 and a reminding module 420.

The second detection module 418 may detect whether the current geographical position is within the reminding range, if the first detection module 304 detects that the current geographical position is not within the display range of the reminder item.

The reminding module 420 may remind the user about the reminder item according to a predetermined reminding manner, if the second detection module 418 detects that the current geographical position is within the reminding range.

The reminding module 420 may include an acquisition submodule 420a, a popup submodule 420b, and a reminding submodule 420c.

The acquisition submodule 420a may acquire an ambient light intensity of the terminal.

The popup submodule 420b may turn on the screen of the terminal based on the ambient light intensity. For example, if the ambient light intensity acquired by the acquisition submodule 420a is larger than a predetermined light threshold, the popup submodule 420b may turn on the screen of the terminal to pop up a prompt box for prompting the reminding content on the screen.

The reminding submodule 420c may remind the user about the reminder item if the ambient light intensity acquired by the acquisition submodule 420a is smaller than the predetermined light threshold. For example, the reminding submodule 420c may remind the user by a vibration manner or an audible signal such as a ring.

In another example, the device may further include a modification module 422.

The modification module 422 may modify a reminding attribute of the reminder item. The terminal may remind the user about the reminder item in the reminding range based on the reminding attribute. For example, the terminal may remind the user if the reminding attribute is enabled, else if the attribute is disabled, the terminal may not remind the user in the reminding range. After the reminding module 420 reminds the user about the reminder item the terminal may disable the attribute so that the user is not disturbed by repetitive reminders.

In another example, the terminal may facilitate the user to select a reminding time period for the reminder item.

If the current moment is within the reminding time period, the display module 306 may display the item content of the reminder item.

The device may, thus, remind the user about the reminder item when display the lock screen interface of the terminal based on a geographical position and/or time. For example, if the current geographical position of the terminal is within a display range, then the reminder item content may be displayed on the lock screen interface. The device, thus, solves the technical problem of limiting reminders only according to the time, by implementing reminding the user when the terminal is in the set display range. Thus, the device improves the reminding frequency.

The device further facilitates setting a display range and a reminding range for the reminder item. When the terminal is outside the display range but within the reminding range, the device may prompt the user about the reminder item. Thus, the device may avoid the situation that the user misses the reminder item, because the user does not view the lock screen interface within the display range.

The device may remind the user based on the ambient light intensity of the terminal. For example, when the ambient light intensity of the terminal is larger than the predetermined light threshold, the device may trigger the screen of the terminal to switch on. The device may further pop up the prompt box for displaying the reminding content on the screen. Alternatively, when the ambient light intensity of the terminal is smaller than the predetermined light threshold, the device may prompt the user about the reminder item using vibration or an audible such as a ring. Therefore, the device may solve the problem of the user not being effectively reminded of the reminder item contents displayed on the lock screen interface when the terminal is put in a pocket or a bag. Thus, the user may be reminded of the relevant reminder item when the terminal is put in a pocket or a bag.

After reminding the user about the reminder item, the device may modify the reminding attribute of the reminder item. The device may modify the reminding attribute such that the user is no longer reminder about the reminder item within the reminding range. the device may thus, avoid the user from being disturbed due to frequent reminders from the terminal outside the display range but in the reminding range.

The device may facilitate setting a reminding time period for the reminder item. The device may trigger display of the reminder item content on the lock screen interface when both, the current time is in the reminding time period, and the current position is in the display range. The reminding time period and the display range may be in the settings of the reminder item. Thus the device may avoid the user being disturbed due to frequent reminders outside the reminding time period, and thereby improving precision of the reminders.

The device may implement one or more of methods for displaying the reminder item content, such as the example methods described throughout the present document. The device may include at least a processor and a memory for storing instructions executable by the processor. The processor may perform the steps of the methods as provided in the instructions stored on the memory. For example, the processor may acquire the current geographical position of the terminal when displaying the lock screen interface of the terminal. The processor may detect whether the current geographical position is within the display range of the reminder item. If the current geographical position is within the display range, the processor may display the reminder item content on the lock screen interface.

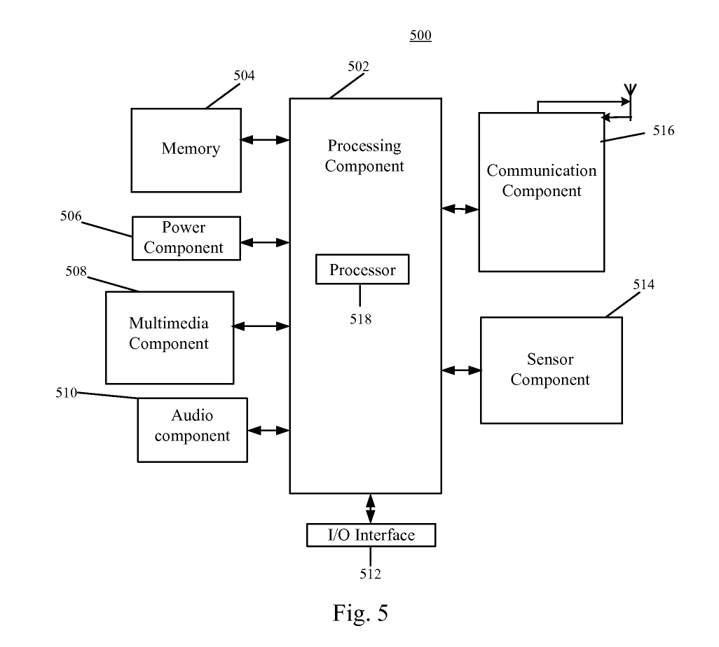

FIG. 5 illustrates an example block diagram of a device for displaying content of a reminder item. For example, the device 500 may be a mobile phone, a computer, a digital broadcast terminal, a messaging device, a gaming console, a tablet, a medical device, exercise equipment, a personal digital assistant, and the like.

The device 500 may include one or more of the following components: a processing component 502, a memory 504, a power component 506, a multimedia component 508, an audio component 510, an input/output (I/O) interface 512, a sensor component 514, and a communication component 516.

The processing component 502 typically controls overall operations of the device 500, such as the operations associated with display, telephone calls, data communications, camera operations, and recording operations. The processing component 502 may include one or more processors 518 to execute instructions to perform all or part of the steps in the above described methods. Moreover, the processing component 502 may include one or more modules which facilitate the interaction between the processing component 502 and other components. For instance, the processing component 502 may include a multimedia module to facilitate the interaction between the multimedia component 508 and the processing component 502.

The memory 504 is configured to store various types of data to support the operation of the device 500. Examples of such data include instructions for any applications or methods operated on the device 500, contact data, phonebook data, messages, pictures, video, etc. The memory 504 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 506 provides power to various components of the device 500. The power component 506 may include a power management system, one or more power sources, and any other components associated with the generation, management, and distribution of power in the device 500.

The multimedia component 508 includes a screen providing an output interface between the device 500 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 508 includes a front camera and/or a rear camera. The front camera and/or the rear camera may receive an external multimedia datum while the device 500 is in an operation mode, such as a photographing mode or a video mode. Each of the front camera and the rear camera may be a fixed optical lens system or have focus and optical zoom capability.

The audio component 510 is configured to output and/or input audio signals. For example, the audio component 510 includes a microphone (“MIC”) configured to receive an external audio signal when the device 500 is in an operation mode, such as a call mode, a recording mode, and a voice recognition mode. The received audio signal may be further stored in the memory 504 or transmitted via the communication component 516. In some embodiments, the audio component 510 further includes a speaker to output audio signals.

The I/O interface 512 provides an interface between the processing component 502 and peripheral interface modules, such as a keyboard, a click wheel, buttons, and the like. The buttons may include, but are not limited to, a home button, a volume button, a starting button, and a locking button.

The sensor component 514 includes one or more sensors to provide status assessments of various aspects of the device 500. For instance, the sensor component 514 may detect an open/closed status of the device 500, relative positioning of components, e.g., the display and the keypad, of the device 500, a change in position of the device 500 or a component of the device 500, a presence or absence of user contact with the device 500, an orientation or an acceleration/deceleration of the device 500, and a change in temperature of the device 500. The sensor component 514 may include a proximity sensor configured to detect the presence of nearby objects without any physical contact. The sensor component 514 may also include a light sensor, such as a CMOS or CCD image sensor, for use in imaging applications. In some embodiments, the sensor component 514 may also include an accelerometer sensor, a gyroscope sensor, a magnetic sensor, a pressure sensor, or a temperature sensor.

The communication component 516 is configured to facilitate communication, wired or wirelessly, between the device 500 and other devices. The device 500 can access a wireless network based on a communication standard, such as Wi-Fi, 2G, or 3G, or a combination thereof. In one exemplary embodiment, the communication component 516 receives a broadcast signal or broadcast associated information from an external broadcast management system via a broadcast channel. In one exemplary embodiment, the communication component 516 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the device 500 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described method for displaying item content.

In exemplary embodiments, there is also provided a non-transitory computer-readable storage medium including instructions, such as included in the memory 504, executable by the processor 518 in the device 500, for performing the above-described methods. For example, the non-transitory computer-readable storage medium may be a ROM, a RAM, a CD-ROM, a magnetic tape, a floppy disc, an optical data storage device, and the like.

The device described throughout the present disclosure may be implemented in many different ways. Each module, such as the first acquisition module 302, the first detection module 304, the display module 306, the second acquisition module 408, the third acquisition module 410, the determination module 412, the receiving module 414, the addition module 416, the second detection module 418, the reminding module 420, and the modification module 422, and the respective submodules may be hardware or a combination of hardware and software. For example, each module may include an application specific integrated circuit (ASIC), a Field Programmable Gate Array (FPGA), a circuit, a digital logic circuit, an analog circuit, a combination of discrete circuits, gates, or any other type of hardware or combination thereof. Alternatively or in addition, each module may include memory hardware, such as a portion of memory 504, for example, that comprises instructions executable with the processor 518 or other processor to implement one or more of the features of the module. When any one of the module includes the portion of the memory that comprises instructions executable with the processor, the module may or may not include the processor. In some examples, each module may just be the portion of the memory 504 or other physical memory that comprises instructions executable with the processor 518 or other processor to implement the features of the corresponding component without the component including any other hardware. Because each module includes at least some hardware even when the included hardware comprises software, each component may be interchangeably referred to as a hardware module.

Some features are shown stored in a computer readable storage medium (for example, as logic implemented as computer executable instructions or as data structures in memory). All or part of the system and its logic and data structures may be stored on, distributed across, or read from one or more types of computer readable storage media. Examples of the computer readable storage medium may include a hard disk, a floppy disk, a CD-ROM, a flash drive, a cache, volatile memory, non-volatile memory, RAM, flash memory, or any other type of computer readable storage medium or storage media. The computer readable storage medium may include any type of non-transitory computer readable medium, such as a CD-ROM, a volatile memory, a non-volatile memory, ROM, RAM, or any other suitable storage device. However, the computer readable storage medium is not a transitory transmission medium for propagating signals.

All of the discussion, regardless of the particular implementation described, is exemplary in nature, rather than limiting. For example, although selected aspects, features, or components of the implementations are depicted as being stored in memories, all or part of the system or systems may be stored on, distributed across, or read from other computer readable storage media, for example, secondary storage devices such as hard disks, flash memory drives, floppy disks, and CD-ROMs. Moreover, the various components and screen display functionality is but one example of such functionality and any other configurations encompassing similar functionality are possible.

The respective logic, software or instructions for implementing the processes, methods and/or techniques discussed above may be provided on computer readable storage media. The functions, acts or tasks illustrated in the figures or described herein may be executed in response to one or more sets of logic or instructions stored in or on computer readable media. The functions, acts or tasks are independent of the particular type of instructions set, storage media, processor or processing strategy and may be performed by software, hardware, integrated circuits, firmware, micro code and the like, operating alone or in combination. Likewise, processing strategies may include multiprocessing, multitasking, parallel processing and the like. In one embodiment, the instructions are stored on a removable media device for reading by local or remote systems. In other embodiments, the logic or instructions are stored in a remote location for transfer through a computer network or over telephone lines. In yet other embodiments, the logic or instructions are stored within a given computer, central processing unit (“CPU”), graphics processing unit (“GPU”), or system.

Furthermore, although specific components are described above, methods, systems, and articles of manufacture described herein may include additional, fewer, or different components. For example, a processor may be implemented as a microprocessor, microcontroller, application specific integrated circuit (ASIC), discrete logic, or a combination of other type of circuits or logic. Similarly, memories may be DRAM, SRAM, Flash or any other type of memory. Flags, data, databases, tables, entities, and other data structures may be separately stored and managed, may be incorporated into a single memory or database, may be distributed, or may be logically and physically organized in many different ways. The components may operate independently or be part of a same program or apparatus. The components may be resident on separate hardware, such as separate removable circuit boards, or share common hardware, such as a same memory and processor for implementing instructions from the memory. Programs may be parts of a single program, separate programs, or distributed across several memories and processors.

A second action may be said to be “in response to” a first action independent of whether the second action results directly or indirectly from the first action. The second action may occur at a substantially later time than the first action and still be in response to the first action. Similarly, the second action may be said to be in response to the first action even if intervening actions take place between the first action and the second action, and even if one or more of the intervening actions directly cause the second action to be performed. For example, a second action may be in response to a first action if the first action sets a flag and a third action later initiates the second action whenever the flag is set.

To clarify the use of and to hereby provide notice to the public, the phrases “at least one of <A>, <B>, . . . and <N>” or “at least one of <A>, <B>, . . . <N>, or combinations thereof” or “<A>, <B>, . . . and/or <N>” are to be construed in the broadest sense, superseding any other implied definitions hereinbefore or hereinafter unless expressly asserted to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed.

While various embodiments have been described, it will be apparent to those of ordinary skill in the art that many more embodiments and implementations are possible. Accordingly, the embodiments described herein are examples, not the only possible embodiments and implementations.

What is claimed is:

1. A method for displaying an interface item on a lock screen interface of a terminal, the method comprising:
acquiring a current geographical position of the terminal;
storing a predetermined geographical display range for a reminder item;
storing a predetermined geographical reminding range for the reminder item
detecting whether the current geographical position is within the predetermined geographical display range of the reminder item;
in response to the current geographical position being within the display range of the reminder item, displaying the interface item on the lock screen interface, wherein the interface item displays content of the reminder item;
in response to the current geographical position being outside the predetermined geographical display range of the reminder item, detecting whether the current geographical position is within the predetermined geographical reminding range of the reminder item; and
in response to the current geographical position being within the predetermined geographical reminding range of the reminder item, initiating a reminder interaction for the reminder.

2. The method according to claim 1, wherein the method further comprises:
configuring the reminder item by:
acquiring a geographical position of the terminal during the configuration of the reminder item; and
configuring the predetermined geographical display range for the reminder item based on the geographical position, the predetermined geographical display range being a geographical range in which the reminder item is displayed on the lock screen interface.

3. The method according to claim 1, wherein the method further comprises:
configuring the predetermined geographical reminding range by:
receiving a distance value, and
calculating the predetermined geographical reminding range based on the predetermined geographical display range and the distance value by:
using a center of the display range as a center of the reminding range, and determining a boundary of the reminding range such that the reminding range is larger than the display range, and a distance between a first intersection point of a ray emitted from the center of the display range and the boundary of the reminding range and a second intersection point of the ray on a boundary of the display range is equal to the received distance value; and
adding the reminding range into the reminder item.

4. The method according to claim 3, wherein the reminder interaction for the reminder item that is initiated in response to the current geographical position being within the predetermined geographical reminding range is based on a predetermined interaction configuration.

5. The method according to claim 4, wherein initiating the reminder interaction for the reminder item comprises:
detecting an ambient light intensity of the terminal;
in response to the ambient light intensity being higher than a predetermined light threshold, causing a screen of the terminal to display the interface item with the content of the reminder item; and
in response to the ambient light intensity being lower than the predetermined light threshold, causing the terminal to vibrate or ring.

6. The method according to claim 4, wherein the method further comprises:
after initiating the reminder interaction for the reminder item, disabling the reminder item from further initiating the reminder interaction in the reminding range.

7. The method according to claim 1, wherein the reminder item has a corresponding time period, and the method further comprises:
displaying the interface item with the content of the reminder item in response to current time being within the time period.

8. The method according to claim 2, wherein the reminder item has a corresponding time period, and the method further comprises:
displaying the interface item with the content of the reminder item in response to current time being within the time period.

9. The method according to claim 3, wherein the reminder item has a corresponding time period, and the method further comprises:
displaying the interface item with the content of the reminder item in response to current time being within the time period.

10. The method according to claim 4, wherein the reminder item has a corresponding time period, and the method further comprises:
displaying the interface item with the content of the reminder item in response to current time being within the time period.

11. The method according to claim 5, wherein the reminder item has a corresponding time period, and the method further comprises:
displaying the interface item with the content of the reminder item in response to current time being within the time period.

12. A device for providing a reminder, wherein the device comprises:
a processor; and
a memory for storing instructions executable by the processor;
wherein the processor is configured to:
display a lock screen interface of the device;
determine a current geographical position of the device;
setup a reminder item, wherein the reminder item has a corresponding display range, which is a geographical range;
identify the current geographical position being within the geographical range of the reminder item; and
in response to the current geographical position being within the geographical range, display content of the reminder item on the lock screen interface.

13. The device according to claim 12, wherein to setup the reminder item the processor is further configured to:
determine a geographical position of the device during the setup of the reminder item; and
calculate the display range of the reminder item based on the determined geographical position.

14. The device according to claim 12, wherein to setup the reminder item the processor is further configured to:
receive a distance value; setup a reminding range corresponding to the display range, wherein the reminding range is a geographical range, with a center of the reminding range being the same as a center of the display range, the reminding range being larger than the display range, and a distance between a first intersection point of a ray emitted from the center on an edge of the reminding range and a second intersection point of the ray on an edge of the display range is equal to the received distance value; and
add the reminding range into the reminder item.

15. The device according to claim 14, wherein the processor is further configured to:
in response to the current geographical position not being within the display range of the reminder item, detect whether the current geographical position is within the reminding range of the reminder item; and
in response to the current geographical position being within the reminding range of the reminder item, trigger the reminder for the reminder item based on the reminder item setup.

16. The device according to claim 15, wherein to setup the reminder item the processor is further configured to:
detect an ambient light intensity of the device;
in response to the ambient light intensity being greater than a predetermined light threshold, trigger the reminder by causing the device to display the content of the reminder item on the screen; and
in response to the ambient light intensity lesser than the predetermined light threshold, trigger the reminder of the reminder item by causing the device to vibrate or ring.

17. The device according to claim 15, wherein the processor is further configured to:
disable the reminder item to further trigger a reminder in the reminding range.

18. The device according to claim 12, wherein the reminder item has a corresponding time period, and the processor is further configured to:
display the interface item with the content of the reminder item in response to current time being within the time period.

19. The device according to claim 13, wherein the reminder item has a corresponding time period, and the processor is further configured to:
display the interface item with the content of the reminder item in response to current time being within the time period.

20. A non-transitory readable storage medium comprising instructions that are executable by a processor in a terminal for performing a method for providing a reminder via the terminal, the method comprising:
displaying a lock screen interface of the terminal;
detecting a current geographical position of the terminal;
determining the current geographical position being within a display range of a reminder item, the display range being a geographical range; and
in response to the current geographical position being within the display range of the reminder item, triggering the reminder for the reminder item by displaying content of the reminder item on the lock screen interface.
